(19) United States
(12) Patent Application Publication
(10) Pub. No.: US 2010/0226611 A1
(43) Pub. Date: Sep. 9, 2010

(54) Optical module

(75) Inventors: Masanori Goto, Hong Kong (CN); Masahiro Onishi, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/656,350

(22) Filed: Jan. 27, 2010

(30) Foreign Application Priority Data
Mar. 3, 2009 (JP) 2009-048876

(51) Int. Cl. G02B 6/36; G02B 6/00; B23P 11/00

(52) U.S. Cl. 385/88; 385/137; 29/428

(57) ABSTRACT

Provided is an optical module which includes: an optical fiber; and a holder which holds an end-face side of the optical fiber and also carries a lens for condensing light to the end face of the optical fiber. The holder includes a loading face for loading a side-face side of the optical fiber and an abutting face to which the end face of the optical fiber is abutted so as to locate the end face of the optical fiber at a position where the light is condensed by the lens, and an upper area of the loading face is opened so that the optical fiber can be moved and loaded from the above the loading face.

### TECHNICAL FIELD

The present invention relates to an optical module and, more specifically, to an optical module in which an optical fiber and an optical fiber holder that holds the end face of the optical fiber are unified.

### BACKGROUND ART

There is an optical receptacle as a component which forms an optical module by connecting an optical fiber and an optical device such as an optical element and a lens. As shown in Patent Document 1, this optical receptacle includes a built-in optical fiber stub for propagating optical signals by being connected to the optical fiber.

However, with the optical receptacle including the built-in optical fiber stub, a large connection loss is generated in the optical fiber and the property thereof I deteriorated if a foreign matter is attached to the end face of the optical fiber stub where the optical fiber is connected. In order to overcome such issues, Patent Document 1 discloses a structure with which the end face of the optical fiber stub within the optical receptacle can be exposed. Specifically, it is the structure capable of detaching a sleeve case which covers the periphery of the vicinity of the end face of the optical fiber stub from the optical receptacle. This makes it possible to expose the end face of the optical fiber stub to remove the foreign matter therefrom.

In the meantime, as shown in FIG. 1, in an optical receptacle 100 used for an optical USB, a lens section 101 and a holder section 102 are unified, and the end face of an optical fiber 200 is abutted against the terminal wall of a hole 103 formed in the holder section 102 leading to the lens section 101. When manufacturing an optical module in which the optical fiber 200 is held by the receptacle 100, first, the optical fiber 200 to which preprocessing such as removal of covering and cutting of the optical fiber has been done is inserted to the hole 103 formed in the holder section 102 leading to the lens section 101, and the position is adjusted so that an abutting face that is the terminal end of the hole 103 and the optical fiber end face abut against each other. Thereafter, the optical fiber 200 and the optical receptacle 100 are fixed by an ultraviolet curing resin to manufacture the optical module in which the optical receptacle 100 and the optical fiber 200 are unified.

### Patent Document 1: Japanese Unexamined Patent Publication 2003-270495

However, with the optical module of the above-described structure, if a foreign matter is attached to the end face of the optical fiber 200 when inserting it to the hole 103 formed in the optical receptacle 100 as shown with an arrow Y100 of FIG. 2, the foreign matter cannot be removed. This results in having an issue of large connection loss in the optical fiber and degradation of the property thereof. Particularly, it is desired for the material of the optical receptacle 100 not to absorb condensed light and to be of fine moldability for reducing the cost, so that optical plastics are used in many cases. Further, the edge of the optical fiber 200 whose end face has been exposed is extremely sharp, and the material of the optical fiber 200 is hard glass. Thus, the plastics forming the optical receptacle 100 may be scraped off when inserting the optical fiber 200. Specifically, the plastics such as burrs in the periphery of a tapered area 104 and the hole 103 formed in the holder section 102 of the optical receptacle 100 are scraped off, and the optical fiber 200 is inserted to the hole 103 together with the shavings. Thereby, the shavings are remained attached to the end face of the optical fiber 200, which turn into foreign matters that interrupt propagation of optical signals.

### SUMMARY

It is therefore an exemplary object of the present invention to suppress the connection loss in the optical fiber, which is the above-described issue, and to provide a high-quality optical module.

In order to achieve the foregoing exemplary object, the optical module as an exemplary embodiment of the present invention employs a structure which includes: an optical fiber; and a holder which holds an end face side of the optical fiber and also carries a lens for condensing light to the end face of the optical fiber. The holder includes a loading face for loading a side-face side of the optical fiber and an abutting face to which the end face of the optical fiber is abutted so as to locate the end face of the optical fiber at a position where the light is condensed by the lens. An upper area of the loading face is opened so that the optical fiber can be moved and loaded from the above the loading face.

Further, the optical fiber holder as another exemplary embodiment of the present invention is an optical fiber holder which holds an end-face side of an optical fiber and also carries a lens for condensing light to the end face of the optical fiber. The optical fiber holder employs a structure in which: the holder includes a loading face for loading a side-face side of the optical fiber and an abutting face to which the end face of the optical fiber is abutted so as to set the end face of the optical fiber at a position where the light is condensed by the lens; and an upper area of the loading face is opened so that the optical fiber can be moved and loaded from above the loading face.

Furthermore, the optical module manufacturing method as still another exemplary embodiment of the present invention is an optical fiber manufacturing method by executed mounting an optical fiber to a holder which holds an end-face side of the optical fiber and also carries a lens for condensing light to the end face of the optical fiber. The method employs a structure which includes: moving the optical fiber from above a loading face of the holder towards the loading face to load a side-face side of the optical fiber on the loading face; and abutting the end face of the optical fiber to an abutting face of the holder to set the end face of the optical fiber at a position where light is condensed by the lens.

The present invention is structured in the above-described manner, so that it is possible to suppress attachment of the foreign matters such as the shavings to the end face of the optical fiber. This makes it possible to suppress the connection loss in the optical fiber, and to improve the quality of the optical module.

### BRIEF DESCRIPTION OF THE DRAWINGS

FIG. 1 is an illustration showing the structure of an optical module related to the present invention;

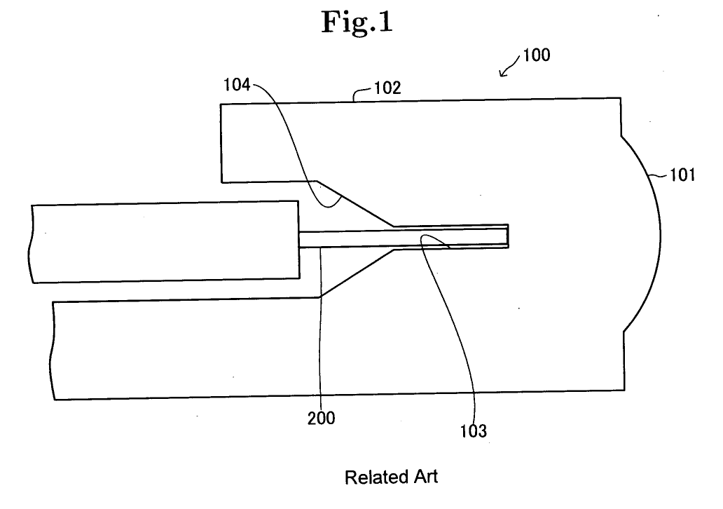

FIG. 2 is an illustration showing a manufacturing method of the optical module disclosed in FIG. 1;

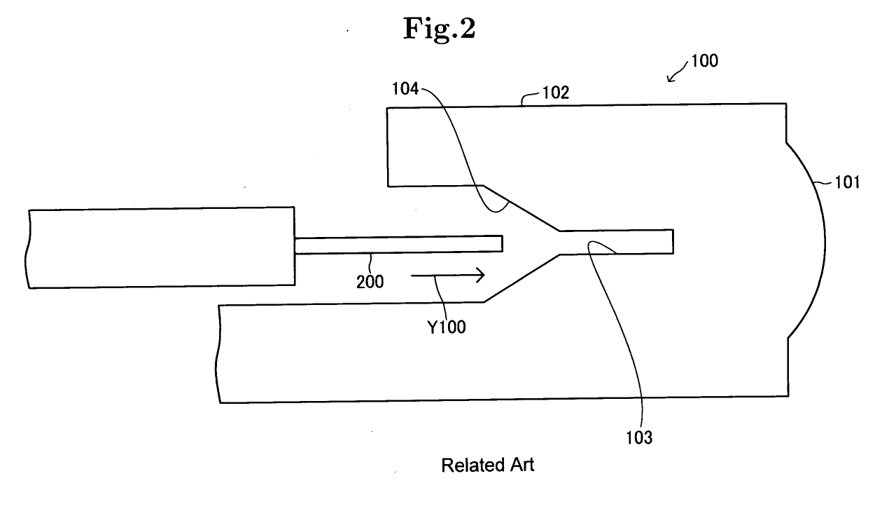

FIG. 3 is a sectional view showing the structure of an optical module according to the present invention;

FIG. 4 is a sectional view of the optical module disclosed in FIG. 3 taken along the line A-A;

FIG. 6 is an illustration showing a state of manufacturing the optical module;

FIG. 7 is an illustration showing a state of manufacturing the optical module;

FIG. 8 is an illustration showing a state of manufacturing the optical module;

FIG. 9 is a flowchart showing a manufacturing method of the optical module;

FIG. 10 is an illustration for describing the structure of the optical module;

FIG. 11 is an illustration showing a state of manufacturing the optical module; and

FIG. 12 is an illustration showing a state of manufacturing the optical module.

### EXEMPLARY EMBODIMENTS

### First Exemplary Embodiment

First, in a first exemplary embodiment, outlines of the structure of an optical module as the present invention will be described.

The optical module as an exemplary embodiment of the present invention employs a structure which includes: an optical fiber; and a holder which holds an end face side of the optical fiber and also carries a lens for condensing light to the end face of the optical fiber. The holder includes a loading face for loading a side-face side of the optical fiber and an abutting face to which the end face of the optical fiber is abutted so as to locate the end face of the optical fiber at a position where the light is condensed by the lens. An upper area of the loading face is opened so that the optical fiber can be moved and loaded from the above the loading face.

With the optical module of the above-described structure, the end-face side of the optical fiber is loaded on the loading face by moving the optical fiber from the above the loading face formed on the holder, and the end face of the optical fiber is abutted against the abutting face. Thereby, the optical fiber can be placed at an appropriate position and held by the holder. Particularly, it is possible to prevent the end face of the optical fiber from abutting against the holder itself, when moving the optical fiber to be placed on the holder. Thus, it is possible to prevent the holder from being scraped off by the end face of the optical fiber. As a result, it is possible to suppress attachment of foreign matters such as shavings to the end face of the optical fiber. This makes it possible to suppress the connection loss in the optical fiber, so that the quality of the optical module can be improved.

Further, the optical module employs a structure in which: the loading face provided to the holder includes a groove section in a prescribed length extended along the length direction of the optical fiber, which is formed in a prescribed depth so that the optical fiber can be loaded in a state where at least a part of the side-face side of the optical fiber is being buried.

Thereby, the optical fiber can be loaded while a part thereof is being buried in the groove section, so that the holding state of the optical fiber by the holder can be stabilized. Therefore, the quality of the optical module can be improved.

Further, the optical module employs a structure in which: the holder includes, between the abutting face and the loading face, an end-face relief concave section that is in a shape recessed from the loading face.

This makes it possible to prevent the end face of the optical fiber from being in contact with the holder itself through moving the optical fiber in a state where the end face of the optical fiber is located in the concave section and through loading it on the loading face when mounting the optical fiber. Therefore, it is possible to prevent the holder from being scraped off by the end face of the optical fiber, which makes it possible to suppress attachment of foreign matters such as shavings to the end face of the optical fiber. As a result, the connection loss in the optical fiber can be suppressed, so that the quality of the optical module can be improved further.

Furthermore, the optical fiber employs a structure in which: a covering member that covers the periphery of the side face of the optical fiber is removed from the end face of the optical fiber to an area distant by a prescribed distance therefrom; and the holder includes a covering relief concave section in a shape recessed from the loading face at a place where the end of the covering member on the optical fiber is located.

Further, the optical module employs a structure in which: the holder includes a covering-member loading face for loading an area of the optical fiber covered by the covering member, which is formed to be higher than the covering relief concave section and lower than the loading face on a side closer to an area where the covering member of the optical fiber is located than to the covering relief concave section.

This makes it possible to relief the deformation of the covering member by the concave section through locating the end part of the covering member of the optical fiber at the covering relief concave section. Therefore, the optical fiber can be held by stabilizing the position of the end face of the optical fiber, so that the quality of the optical fiber can be improved still further.

Furthermore, the optical module employs a structure in which: a covering member that covers periphery of the side face of the optical fiber is removed from the end face of the optical fiber to an area distant by a prescribed distance therefrom; and the loading face provided to the holder is formed in a protruded shape at a place distant by a prescribed distance from the abutting face along a longitudinal direction of the optical fiber to be loaded so that an area of the optical fiber from which the covering member is removed can be loaded thereon.

Further, the optical module employs a structure in which the holder includes a pressing member which presses the optical fiber placed on the loading face towards the loading face side from the above the loading face.

Furthermore, the optical module employs a structure in which the optical fiber placed on the loading face of the holder is tightly fixed to the holder by a resin.

This makes it possible to press the optical fiber down to the loading face with the pressing member or to tightly fix the optical fiber by the resin, so that optical fiber can be held while stabilizing the position of the end face of the optical fiber by the holder. Therefore, the quality of the optical module can be improved further.

Further, the optical fiber holder as another exemplary embodiment of the present invention is an optical fiber holder which holds an end-face side of an optical fiber and also carries a lens for condensing light to the end face of the optical fiber. The optical fiber holder employs a structure in which: the holder 10, includes a loading face for loading a side-face side of the optical fiber and an abutting face to which the end face of the optical fiber is abutted so as to set the end face of the optical fiber at a position where the light is condensed by the lens; and an upper area of the loading face is opened so that the optical fiber can be moved and loaded from above the loading face.

Furthermore, the optical module manufacturing method as still another exemplary embodiment of the present invention is an optical fiber manufacturing method by executed mounting an optical fiber to a holder which holds an end-face side of the optical fiber and also carries a lens for condensing light to the end face of the optical fiber. The method employs a structure which includes: moving the optical fiber from above a loading face of the holder towards the loading face to load a side-face side of the optical fiber on the loading face; and abutting the end face of the optical fiber to an abutting face of the holder to set the end face of the optical fiber at a position where light is condensed by the lens.

Further, the optical module manufacturing method employs a structure in which: the optical fiber is moved towards the loading face to load the side-face side of the optical fiber on the loading face in a state where the end face of the optical fiber is located above an end-face relief concave section that is in a recessed shape than the loading face formed between the abutting face and the loading face of the holder; the end face of the optical fiber is moved to abut against the abutting face; and the end face of the optical fiber is set at the position where the light is condensed by the lens.

Furthermore, the optical module manufacturing method employs a structure in which: the end face of the optical fiber is set at the position where the light is condensed by the lens so that an area where an end of a covering member that covers periphery of the side face of the optical fiber, which is removed from the end face of the optical fiber to an area distant by a prescribed distance therefrom, comes at a covering relief concave section that is in a shape recessed from the loading face.

Further, the optical module manufacturing method employs a structure which includes: after setting the end face of the optical fiber at the position where the light is condensed by the lens, pressing the optical fiber by a pressing member from above the loading face towards the loading face side.

Furthermore, the optical module manufacturing method employs a structure which includes: after setting the end face of the optical fiber at the position where the light is condensed by the lens, tightly fixing the optical fiber to the holder by a resin.

Inventions of an optical fiber holder or an optical module manufacturing method with the above-described structure also provide the same effects as those of the above-described optical module, so that the exemplary object of the present invention mentioned above can also be achieved therewith.

### Second Exemplary Embodiment

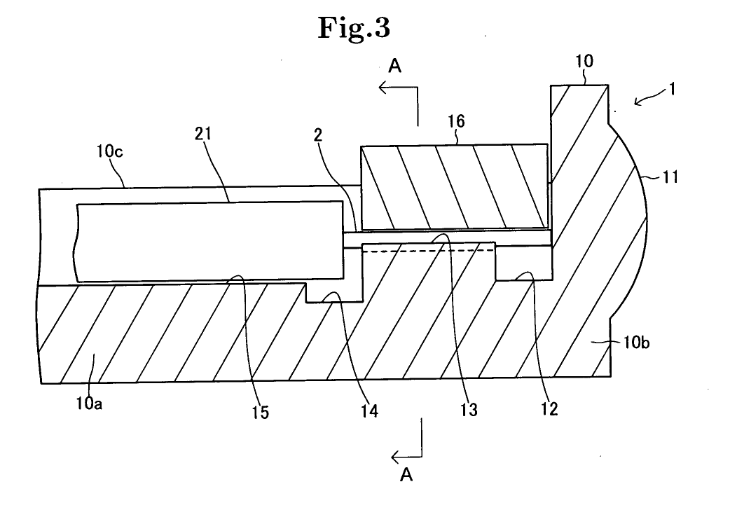

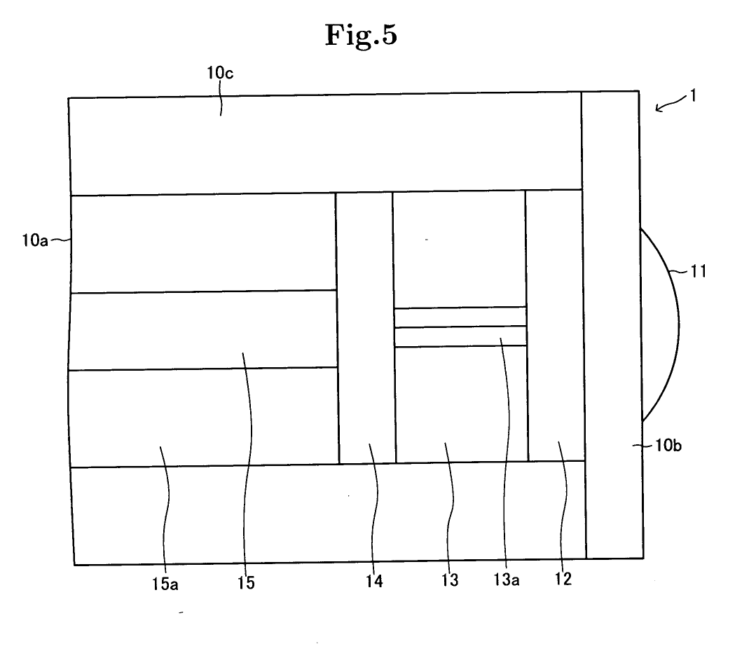

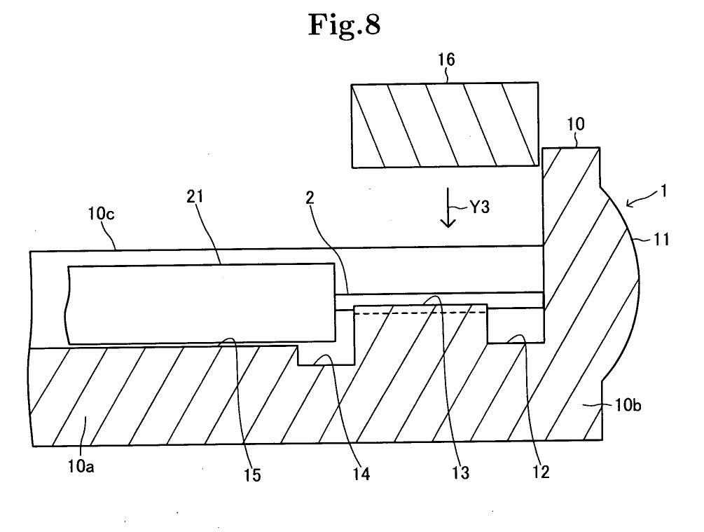

A second exemplary embodiment of the present invention will be described by referring to FIG. 3-FIG. 9. FIG. 3-FIG. 5 are illustrations showing the structure of the optical module. FIG. 6-FIG. 8 are illustrations showing the state of manufacturing the optical module. FIG. 9 is a flowchart showing a manufacturing method of the optical module.

Note here that this exemplary embodiment shows a specific example of the optical module disclosed in the above-described first exemplary embodiment. However, it is to be understood that the optical module according to the present invention is not limited only to the structure described below.

### (Structure)

As shown in FIG. 3, the optical module according to this exemplary embodiment is structured, including: an optical fiber 2; and a holder 1 which holds the end-face side of the optical fiber 2 and carries a lens 11 for condensing light to the end face of the optical fiber 2. Further, a covering member 21 for covering the periphery of the side face of the optical fiber 2 is removed from the end face of the optical fiber 2 to an area distant by a prescribed distance therefrom.

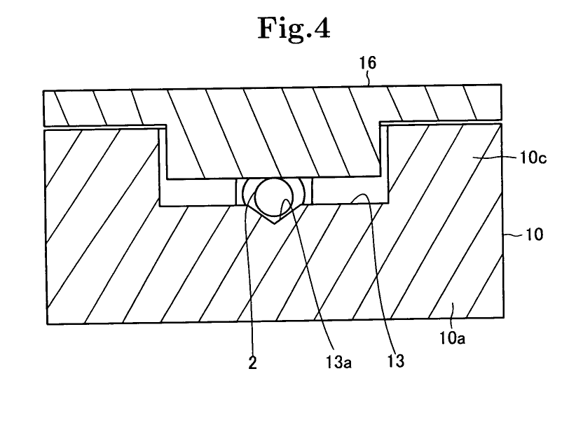

Furthermore, the holder 1 (optical fiber holder) which holds the end-face side of the optical fiber 2 is structured, including: a holder main body 10 on which the optical fiber 2 is loaded; and a pressing member 16 which presses down the optical fiber 2 loaded on the holder 10 from the above. FIG. 3 shows a sectional view of the holder 1 taken along the longitudinal direction of the optical fiber 2 held by the holder 1, and FIG. 4 is a sectional view taken along the A-A line of FIG. 3. Further, FIG. 5 is a plan view of the holder main body 10 that is shown in FIG. 3. Hereinafter, more detailed explanations will be provided.

As shown in FIG. 3, the holder main body 10 includes: a substantially plate-type bottom section 10a; an abutting wall section 10b provided on one end side (on right-end side in FIG. 3) of the bottom section 10a in an almost perpendicular manner with respect to the bottom section 10a; and side-wall sections 10c provided on both sides of the bottom section 10a in an almost perpendicular manner with respect to the bottom section 10a. An inner-wall face (wall face on the left side in FIG. 3) of the abutting wall section 10b is an abutting face to which the end face of the optical fiber 2 is abutted. Further, the lens 11 is provided to an outer-face side (wall face on the right side in FIG. 3). This lens 11 functions to condense the light to the end face of the optical fiber 2 which is positioned by being abutted against the inner-wall face of the abutting wall section 10b.

Further, the surface (the upward face in FIG. 3) of the bottom section 10a of the holder main body 10 is formed in an uneven shape. Specifically, as shown in plan views of FIG. 3 and FIG. 5, an end-face relief concave section 12 recessed from the periphery along the longitudinal direction of the optical fiber 2 to be loaded is formed on the abutting-wall section 10b side. Furthermore, on the opposite side of the abutting-wall section 10b side of the end-face relief concave section 12, a loading face 13 in a protruded shape with respect to the periphery along the longitudinal direction of the optical fiber 2 to be loaded is formed. Moreover, on the opposite side of the end-face relief concave section 12 side of the loading face 13, a covering relief concave section 14 in a recessed shape with respect to the periphery along the longitudinal direction of the optical fiber 2 to be loaded is formed. Further, on the opposite side of the loading face 13 side of the covering relief concave section 14, a covering-member loading face 15 in a protruded shape with respect to the periphery along the longitudinal direction of the optical fiber 2 to be loaded is formed.

The shape of the bottom section 10a of the holder main body 10 will be described in more details. First, the end-face relief concave section 12 is located between the abutting face (inner-wall face) of the abutting-wall section 10b and the loading face 13, and it is formed in a recessed shape with an inner-bottom face that is lower than the height of the loading face 13. Further, as will be described later, the optical fiber 2 is placed to the holder main body 10 while the end face of the optical fiber 2 is being placed above the end-face relief concave section 12.

Further, the loading face 13 is located between the end-face relief concave section 12 and the covering relief concave section 14, and it is formed at a place distant from the abutting-wall section 10b by the width of the end-face relief concave section 12 in a protruded shape that is higher than the height of the inner-bottom faces of each of the concave sections 12, 14 for allowing the top face thereof to be the loading face for the optical fiber 2. Specifically, on the center of the top face of the loading face 13, a groove section 13a in a prescribed depth is formed for enabling at least a part of the side face of the optical fiber to be buried and loaded therein. Further, the shape of this groove section 13a is a V-letter shape as shown in FIG. 4, and it is formed in a prescribed length along the length direction of the optical fiber 2 to be loaded. For example, the length of the groove section 13a is 2 mm for the optical fiber 2 with the diameter of 125 μm.

Further, the covering relief concave section 14 is located between the loading face 13 and the covering-member loading face 15, and it is formed in a recessed shape with the inner-bottom face that is lower than the height of the loading face 13. Specifically, the inner-bottom face of the covering relief concave section 14 is formed at a lower position that is more distant than the distance corresponding to the thickness of the covering member 21 which covers the periphery of the optical fiber 2 with respect to the top face of the loading face 13. Thereby, the covering member 21 which covers the periphery of the optical fiber 2 does not abut against the covering relief concave section 14, when the optical fiber 2 is loaded on the loading face 13 in the manner as described above. Further, as will be described later, in a state where the optical fiber 2 is placed to the holder main body 10, the end of the covering member 21 does not abut against the covering relief concave section 14 but locates at a position above the covering relief concave section 14.

Furthermore, the top face of the covering-member loading face 15 is formed in the height that is between the inner-bottom face of the covering relief concave section 14 and the top face of the loading face 13. Specifically, as described above, it is formed in the height with which the side face of the covering member 21 covering the periphery of the optical fiber 2 abuts against the loading face 13, when the optical fiber 2 is loaded on the loading face 13. On both sides (top and bottom sections in FIG. 5) of the covering-member loading face 15, a covering member peripheral wall section 15a provided in an almost perpendicular manner to the covering-member loading face 15 is formed to surround the periphery of the optical fiber 2.

As described above, the holder main body 10 is formed with the opened loading face 13 on which the optical fiber 2 is loaded (i.e., the upper area of the entire bottom section 10a is open). As will be described later, this makes it possible to move the optical fiber 2 from the above the bottom section 10a to load the optical fiber 2 on the loading face 13 or the like so as to place it on the holder main body 10.

Further, as shown in FIG. 3 and FIG. 4, the pressing member 16 is placed above the optical fiber 2 loaded on the holder main body 10, and it functions to press the optical fiber 2 down towards the loading face from the above the loading face 13.

### (Manufacturing Method)

Next, a manufacturing method of the optical module formed with the optical fiber 2 and the holder 1 in the above-described structure will be described by referring to FIG. 6-FIG. 9.

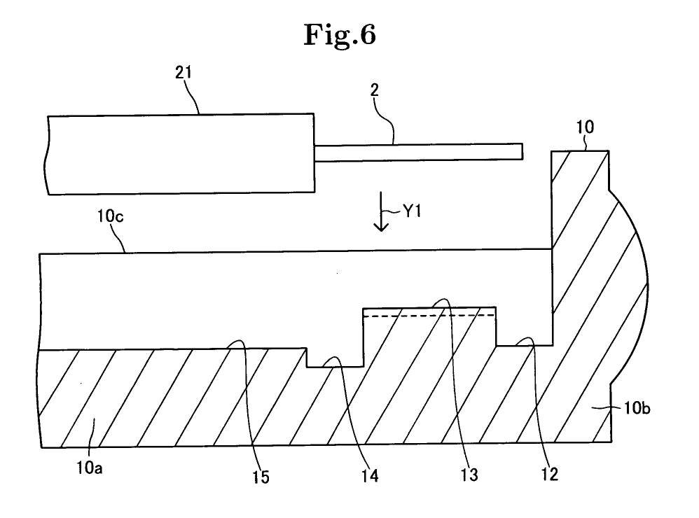

First, as preprocessing, the covering on the end-face side of the cut optical fiber 2 is removed, and the processing of the end face is executed. Subsequently, as shown with an arrow Y1 in FIG. 6, the optical fiber 2 is moved from the above the bottom section 10a of the holder main body 10 to load the optical fiber 2 on the bottom section 10a (step S1). At this time, the optical fiber 2 is moved to the holder main body 10 side in a state where, specifically, the end face of the optical fiber 2 is located above the end-face relief concave section 12 formed in the bottom section 10a of the holder main body 10. Then, the side face of the area (left-side area in FIG. 6) covered by the covering member 21 of the optical fiber 2 is loaded on the covering-member loading face 15, and the side face of the covering removed area (the right-side area in FIG. 6) on the end-face side of the optical fiber 2 is loaded on the grove section 13a that is formed in the loading face 13. Upon this, as shown in FIG. 7, the optical fiber 2 is loaded on the holder main body 10 while the end face of the optical fiber 2 is being loaded above the end-face relief concave section 12.

This makes it possible to prevent the end face of the optical fiber 2 from abutting against the holder main body 10, while moving the optical fiber 2 to load it on the bottom section 10a of the holder main body 10. Thus, it is possible to prevent the holder main body 10 itself from being scraped off by the end face of the optical fiber 2. As a result, attachment of foreign matters such as shavings to the end face of the optical fiber 2 can be suppressed.

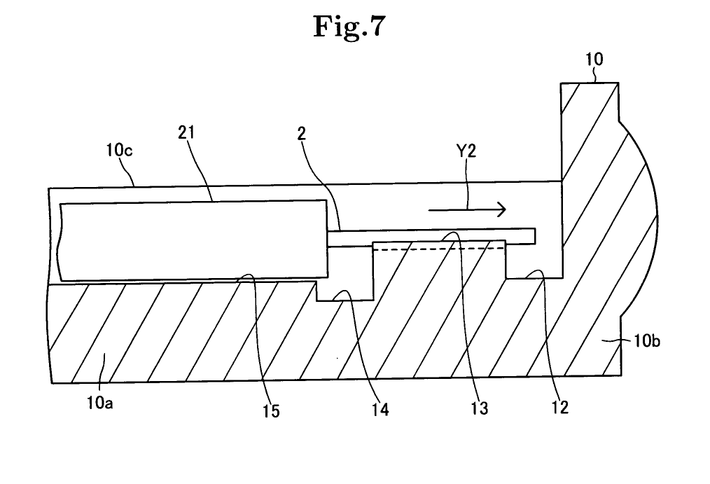

Subsequently, the optical fiber 2 is moved as shown with an arrow Y2 in FIG. 7 to abut the end face of the optical fiber 2 loaded on the bottom section 10a of the holder main body 10 against the inner-wall face (i.e., the abutting face) of the abutting-wall section 10b (step S2). Thereby, as shown in FIG. 8, the end face of the optical fiber 2 can be set to the position where the light is condensed by the lens 11 that is mounted to the holder main body 10.

Further, at this time, the end of the covering member 21 of the optical fiber 2 is located on the covering relief concave section 14, and the end of the covering member 21 is not abutted against the end section 10a. Thus, even if the covering is deformed at the time of removing the covering in the preprocessing described above, the deformed part does not abut against the holder main body 10. Therefore, the loading state of the optical fiber 2 becomes stable.

Subsequently, the position of the optical fiber 2 with respect to the holder main body 10 is tentatively fixed by a clamp (not shown), and an ultraviolet curing resin is applied to the optical fiber 2. Then, as shown with an arrow Y3 in FIG. 8, the pressing member 16 is moved from the above the loading face 13 to be placed on the optical fiber 2 that is loaded on the loading face 13 (step S3). Thereby, the optical fiber 2 is pressed down towards the loading face 13 from the above so that the optical fiber 2 is not floated from the groove section 13a of the loading face 13.

Thereafter, spot cure is applied to connect the holder main body 10, the optical fiber 2, and the pressing member 16 by curing to have them unified (step S4). The resin used as the adhesive is cured by employing ultraviolet curing and thermal curing.

The optical module manufactured in the manner described above can suppress the attachment of foreign matters to the end face of the optical fiber 2, so that the connection loss in the optical fiber can be suppressed. Thus, the quality thereof can be improved to a high quality. Further, the shape of the components is simple and the manufacture thereof is easy, so that the manufacturing cost can be lowered.

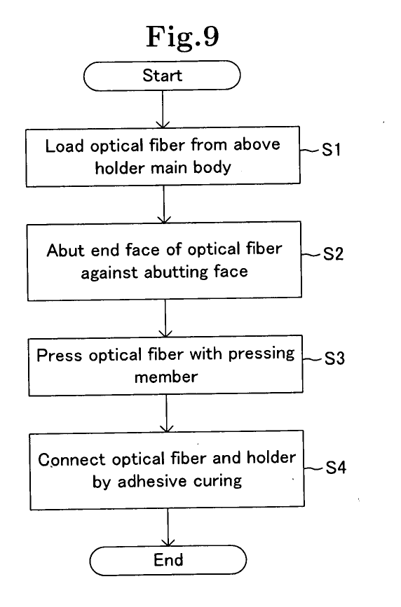

In the above, the structure including the optical fiber 2 and the holder 1 which holds one end of the optical fiber 2 has been described above as the optical module. However, the “optical module” of the present invention is not limited only to the above-described structure. For example, a structure as shown in FIG. 10, which includes the optical fiber 2, a connector 30 provided with the holder 1 which holds one end of the optical fiber, and a light receiving section 41 (PD: photodetector) and/or a light transmitting section 42 (LD: laser diode) provided at the other end of the optical fiber, is also included as the optical module of the present invention. Further, the optical components that include the optical fiber 2 and the holder 1 in the above-described structure are all included as the optical module of the present invention.

### Third Exemplary Embodiment

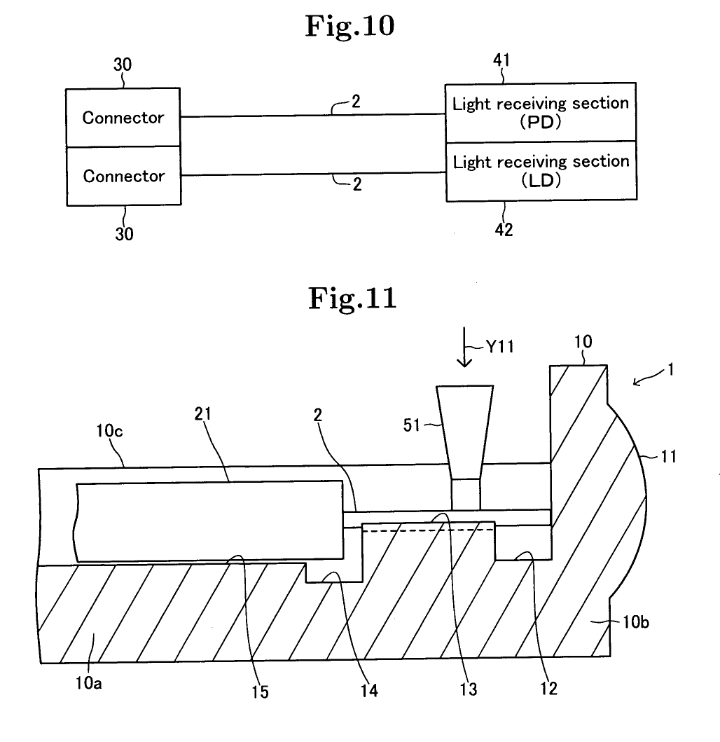

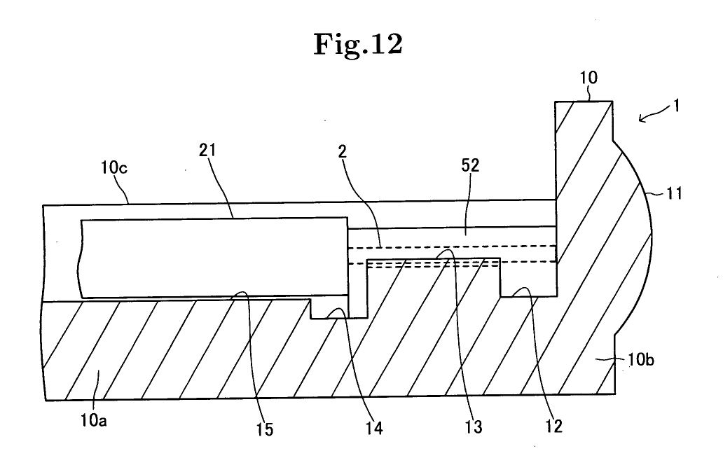

Next, a third embodiment of the present invention will be described by referring to FIG. 11 and FIG. 12. FIG. 11 and FIG. 12 are illustrations showing a manufacturing method of the optical module according to this exemplary embodiment.

For the optical module according to this exemplary embodiment, the method for fixing the optical fiber 2 to the holder 1 is different from the method described in the second exemplary embodiment. Specifically, first, as in the method of the second exemplary embodiment described above, the end face of the optical fiber 2 is abutted against the inner-wall face (i.e., the abutting face) of the abutting-wall section 10b of the holder main body 10, as shown in FIG. 7. Thereby, as shown in FIG. 8, the end face of the optical fiber 2 is set at the position where the light is condensed by the lens 11 that is mounted to the holder main body 10.

Subsequently, in the third exemplary embodiment, the position of the optical fiber 2 with respect to the holder main body 10 is tentatively fixed by pressing it with a clamp 51 from the above as shown in FIG. 11, and an ultraviolet curing resin (not shown) is applied to the optical fiber 2. Then, the applied ultraviolet curing resin is cured to tentatively fix the optical fiber 2 and the holder main body 10.

Thereafter, in the third embodiment, the optical fiber 2 is fixed to the holder main body 10 without using the pressing member 16 shown in FIG. 8 described in the second embodiment. Specifically, as described above, the clamp 51 is taken out from the state where the optical fiber 2 is tentatively fixed to the holder main body 10, and a resin 52 is filled onto the holder main body 10 from the above the optical fiber 2. At this time, as shown in FIG. 12, the resin 52 is filled onto the loading face 13 of the holder main body 10, onto the end-face relief concave section 12, and further onto the covering relief concave section 14 so as to bury the optical fiber 2 therein. Then, the resin 52 is cured to tightly fix the optical fiber 2 to the holder main body 10.

In the case of FIG. 12, the optical fiber 2 is tightly fixed to the holder main body 10 by surrounding the periphery of the optical fiber 2 with the resin 52. However, it is not essential to surround the entire optical fiber 2 with the resin 52. For example, it is also possible to tightly fix the optical fiber 2 to the holder main body 10 by surrounding only a part of the optical fiber 2 with the resin 52.

While the present invention has been described by referring to each of the exemplary embodiments thereof, the present invention is not limited to those embodiments. It will be understood those of ordinary skill in the art that various changes in form and details may be made therein without departing from the spirit and scope of the present invention as defined by the appended claims.

This application is based upon and claims the benefit of priority from Japanese patent application No. 2009-048876, filed on Mar. 3, 2009, the disclosure of which is incorporated herein in its entirety by reference.

The present invention has industrial applicability, since it can be applied to the optical module in which the optical fiber and the holder which holds the end face of the optical fiber are unified.

What is claimed is:

1. An optical module, comprising
an optical fiber, and a holder which holds an end-face side of the optical fiber and also carries a lens for condensing light to the end face of the optical fiber, wherein:
the holder includes a loading face for loading a side-face side of the optical fiber and an abutting face to which the end face of the optical fiber is abutted so as to set the end face of the optical fiber at a position where the light is condensed by the lens; and an upper area of the loading face is opened so that the optical fiber can be moved and loaded from above the loading face.

2. The optical module as claimed in claim 1, wherein
the loading face provided to the holder includes a groove section in a prescribed length extended along the length direction of the optical fiber, which is formed in a prescribed depth so that the optical fiber can be loaded in a state where at least a part of the side-face side of the optical fiber is being buried.

3. The optical module as claimed in claim 1, wherein
the holder includes, between the abutting face and the loading face, an end-face relief concave section that is in a shape recessed from the loading face.

4. The optical module as claimed in claim 1, wherein:
a covering member that covers periphery of the side face of the optical fiber is removed from the end face of the optical fiber to an area distant by a prescribed distance therefrom; and the holder includes a covering relief concave section in a shape recessed from the loading face at a place where an end of the covering member on the optical fiber is located.

5. The optical module as claimed in claim 4, wherein
the holder includes a covering-member loading face for loading an area of the optical fiber covered by the covering member, which is formed to be higher than the covering relief concave section and lower than the loading face on a side closer to an area where the covering member of the optical fiber is located than to the covering relief concave section.

6. The optical module as claimed in claim 1, wherein:
a covering member that covers periphery of the side face of the optical fiber is removed from the end face of the optical fiber to an area distant by a prescribed distance therefrom; and
the loading face provided to the holder is formed in a protruded shape at a place distant by a prescribed distance from the abutting face along a longitudinal direction of the optical fiber to be loaded so that an area of the optical fiber from which the covering member is removed can be loaded thereon.

7. The optical module as claimed in claim 1, wherein
the holder comprises a pressing member which presses the optical fiber placed on the loading face towards the loading face side from above the loading face.

8. The optical module as claimed in claim 1, wherein
the optical fiber placed on the loading face of the holder is tightly fixed to the holder by a resin.

9. An optical fiber holder which holds an end-face side of an optical fiber and also carries a lens for condensing light to the end face of the optical fiber, the holder including
a loading face for loading a side-face side of the optical fiber and an abutting face to which the end face of the optical fiber is abutted so as to set the end face of the optical fiber at a position where the light is condensed by the lens, wherein
an upper area of the loading face is opened so that the optical fiber can be moved and loaded from above the loading face.

10. An optical fiber manufacturing method by mounting an optical fiber to a holder which holds an end-face side of the optical fiber and also carries a lens for condensing light to the end face of the optical fiber, the method comprising:
moving the optical fiber from above a loading face of the holder towards the loading face to load a side-face side of the optical fiber on the loading face; and
abutting the end face of the optical fiber to an abutting face of the holder to set the end face of the optical fiber at a position where light is condensed by the lens.

11. The optical module manufacturing method as claimed in claim 10, wherein:
the optical fiber is moved towards the loading face to load the side-face side of the optical fiber on the loading face in a state where the end face of the optical fiber is located above an end-face relief concave section that is in a recessed shape than the loading face formed between the abutting face and the loading face of the holder;
the end face of the optical fiber is moved to abut against the abutting face; and
the end face of the optical fiber is set at the position where the light is condensed by the lens.

12. The optical module manufacturing method as claimed in claim 10, wherein:
the end face of the optical fiber is set at the position where the light is condensed by the lens so that an area where an end of a covering member that covers periphery of the side face of the optical fiber, which is removed from the end face of the optical fiber to an area distant by a prescribed distance therefrom, comes at a covering relief concave section that is in a shape recessed from the loading face.

13. The optical module manufacturing method as claimed in claim 10, comprising
after setting the end face of the optical fiber at the position where the light is condensed by the lens, pressing the optical fiber by a pressing member from above the loading face towards the loading face side.

14. The optical module manufacturing method as claimed in claim 10, comprising
after setting the end face of the optical fiber at the position where the light is condensed by the lens, tightly fixing the optical fiber to the holder by a resin.
